(19) United States
(12) Patent Application Publication
(10) Pub. No.: US 2026/0128659 A1
(43) Pub. Date: May 7, 2026

(54) MAGNETIC SUSPENSION AND ELECTROMAGNETIC FORCE RECOIL POWER GENERATION DEVICE WITH LONG ROTATING CRANK TO RAPIDLY ROTATE AROUND SHAFT

(71) Applicants: Yuanming YI, Zhuzhou (CN); Huanxun WU, Shenzhen (CN)

(72) Inventor: Yuanming YI, Zhuzhou (CN)

(21) Appl. No.: 19/430,599

(22) Filed: Dec. 23, 2025

Related U.S. Application Data
(63) Continuation of application No. PCT/CN2023/111438, filed on Aug. 7, 2023.

(30) Foreign Application Priority Data
Jul. 12, 2023 (CN) 202310854323.6

(51) Int. Cl. H02K 99/00; H02K 7/075; H02K 55/00

(52) U.S. Cl. CPC H02K 99/10; H02K 7/075; H02K 55/00

(57) ABSTRACT

Disclosed is a magnetic suspension and electromagnetic force recoil power generation device with a long rotating crank to rapidly rotate around a shaft. Under a vacuum working condition, the long rotating crank and an annular slot are arranged around the shaft to form a power rotating disc; a superconducting electromagnet and a superconducting suspension electromagnet which generate a recoil magnetic force are correspondingly arranged in the annular slot and a guide rail respectively; moreover, a phase change cooling device is adopted to produce and provide liquid nitrogen to ensure that a large-flow current circulates in an electromagnetic coil and a theoretical zero resistance is achieved, and therefore a huge electromagnetic force is efficiently generated; and a generator is driven by a mechanical kinetic energy formed by a product of a electromagnetic recoil force and a high advancing speed of the power rotating disc, to achieve high-efficiency and large-scale power generation.

### CROSS-REFERENCE TO RELATED APPLICATIONS

This application is a continuation of International Patent Application No. PCT/CN 2023/111438 with a filing date of Aug. 7, 2023, designating the United States, now pending, and further claims priority to Chinese Patent Application No. 202310854323.6 with a filing date of Jul. 12, 2023. The content of the aforementioned applications, including any intervening amendments thereto, are incorporated herein by reference.

### TECHNICAL FIELD

The present invention relates to a power generation device, and particularly, to a magnetic suspension and electromagnetic force recoil power generation device with a long rotating crank to rapidly rotate around a shaft.

### BACKGROUND OF THE PRESENT INVENTION

An existing mainstream power generation technology adopts fuel oil and coal burning, including nuclear fuel, which generates high-temperature heat to heat and vaporize a liquid thermal working medium, so that it expands at a high volume, drives a heat engine, and then coaxially drives a generator to do work and generate electricity.

The disadvantages of the existing mainstream power generation technology are that a lot of natural mineral resources are consumed, an earth's ecological environment is seriously polluted, and a power generation cost is high.

An existing renewable energy power generation technology adopting sunlight, wind and tidal water to generate electricity, has the disadvantage of low energy density, being seriously limited by a natural condition and being unable to meet world's production and domestic power demands.

Existing magnetic suspension and electromagnetic force technologies are mainly used as a traction power of a train, but have not been effectively used in a power generation device.

In the process of using superconducting magnetic suspension and a superconducting electromagnetic force, an existing conventional refrigeration technology and a device thereof are widely used for providing a low-temperature deep cold cooling capacity, which leads to a low refrigeration efficiency and a high energy cost.

In an existing patent technology with an invention name of a recoil driven power generation device with a long rotating crank to rapidly rotate around a shaft, recoil thrust generating devices used are only thermal, electric, wind and hydraulic recoil thrust generating devices, and the magnetic suspension and the electromagnetic force have not been used for recoil thrust power generation.

### SUMMARY OF THE PRESENT INVENTION

The purpose of the present invention is to provide a magnetic suspension and electromagnetic force recoil power generation device with a long rotating crank to rapidly rotate around a shaft, thereby realizing high-power generation with zero emission, zero pollution and high efficiency.

The technical solution of the present invention is as follows:

A technological method for a magnetic suspension and electromagnetic force recoil power generation device with a long rotating crank to rapidly rotate around a shaft adopts the long rotating crank to rapidly rotate around the shaft for recoil driven power generation; in a working condition of a vacuum state, a large amount of low-temperature cooling capacity with a temperature lower than −196° C. is provided with high efficiency and low energy consumption by adopting new refrigeration technology and device with an invention name of a phase change cold-refrigerating technological method and a device thereof, so as to ensure that an electromagnetic coil in the power generation device is immersed in liquid nitrogen, so that the electromagnetic coil is in a superconducting state with a theoretical zero resistance, and circulates a large current; by taking a machine shaft of the device as a center, a plurality of long rotating cranks rotating around the shaft rapidly are arranged, an annular slot is arranged below an outer edge of the long rotating crank, and a superconducting electromagnet is fixedly arranged in the annular slot; the long rotating crank, the annular slot and the superconducting electromagnet are combined to form a shaft-rotating power rotating disc; a guide rail is arranged corresponding to a position of the superconducting electromagnet in the power rotating disc at an upper part, a superconducting electromagnet corresponding to the superconducting electromagnet in the annular slot is arranged in the guide rail, and the guide rail is fixedly arranged on a device fixedly connected with ground in a vacuum state. The superconducting electromagnet at an edge of the power rotating disc rotating around the machine shaft of the device constantly changes a current direction, so that the electromagnet in the guide rail generates an electromagnetic force with same polarity and repulsion, thereby forming magnetic suspension to overcome a gravity thereof, and then a recoil thrust of the superconducting electromagnet pushes the generator to generate electricity efficiently. The power rotating disc formed by the long rotating crank and the annular slot and rotating rapidly around the machine shaft is adopted. Due to a large diameter of the power rotating disc, in rapid rotation around the shaft, an advancing linear speed of the superconducting electromagnetic coil arranged in the annular slot at the edge of the power rotating disc is large, and a mechanical kinetic energy formed by a product of a recoil electromagnetic force and an acting distance thereof increases synchronously with the linear speed. Therefore, a physical principle that the acting distance of the force and the generated mechanical kinetic energy increase synchronously with a speed of a vehicle propelled by a recoil thrust is effectively utilized and realized. A magnetic suspension method is adopted to enable the power rotating disc with rapid rotating operation work not produce a mechanical friction with a track. A method for enabling the power rotating disc thereof to rotate rapidly in the vacuum state is adopted, so that an air resistance is not generated during a process of operation work and power generation thereof.

In the present invention, the electromagnetic force in the magnetic suspension and electromagnetic force recoil power generation device with the long rotating crank to rapidly rotate around the shaft refers to that magnetic suspension is realized and an electromagnetic force is generated at a working condition of low-temperature superconductivity; that superconducting magnetic suspension is realized and a superconducting electromagnetic force is generated at a working condition of a normal temperature; further that magnetic suspension is realized and an electromagnetic force is generated at a condition of a normal temperature.

In the present invention, the working condition of the magnetic suspension and electromagnetic force recoil power generation device with the long rotating crank to rapidly rotate around the shaft refers to that the power rotating disc is operated to generate electricity by doing work in the vacuum state, that the power rotating disc is operated to generate the electricity by doing work at a working condition of a normal pressure, further that the power rotating disc is operated to generate the electricity by doing work at a state lower than the normal pressure.

A magnetic suspension and electromagnetic force recoil power generation device with a long rotating crank to rapidly rotate around a shaft includes an electromagnet, and further includes a generator, a gearbox, a bearing, a power rotating disc, a machine shaft of the power rotating disc, a vacuum box, the long rotating crank, an annular slot, a guide rail, a superconducting electromagnet for generating a recoil magnetic force, a superconducting suspension electromagnet, a phase change cooling device, a liquid nitrogen storage tank, a storage battery, an electromagnetic coil current commutator, a working medium pump, a nitrogen reflux pipe, a vacuum box pillar, a sealing ring, a vacuum pump, liquid nitrogen, and a wire inlet and outlet pipe.

In the above-mentioned device, the power rotating disc consists of the machine shaft of the power rotating disc, the long rotating crank and the annular slot, wherein a plurality of long rotating cranks are symmetrically arranged, an inner end of the long rotating crank is fixedly connected with the machine shaft of the power rotating disc, and a lower part of an outer end of the long rotating crank is fixedly connected with the annular slot; two inner sides of the annular slot are provided with the superconducting electromagnet for generating the recoil magnetic force, so that the superconducting electromagnet for generating the recoil magnetic force corresponds to the recoil magnetic superconducting electromagnet arranged in a vertical direction of the guide rail to generate a recoil electromagnetic force with the same polarity and repulsion; the superconducting suspension electromagnet is arranged at a bottom of the annular slot, so that the superconducting suspension electromagnet corresponds to the superconducting suspension electromagnet arranged at a bottom of the guide rail to generate a recoil electromagnetic force with the same polarity and repulsion, which overcomes a gravity on the power rotating disc. When the power rotating disc rotates rapidly, a rotating position of the machine shaft of the power rotating disc is fixed by bearings arranged from top to bottom; then a mechanical kinetic energy is transmitted to the gearbox, and then the mechanical kinetic energy is transmitted to the machine shaft of the generator after the gearbox changes a speed. The liquid nitrogen produced by the phase change cooling device is first injected into the liquid nitrogen storage tank, then pumped into a liquid nitrogen output pipe by the working medium pump, and finally injected into the superconducting electromagnet by a branch pipe respectively, and the generated nitrogen enters the nitrogen reflux pipe through the branch pipe and is input into the phase change cooling device; a current in the storage battery is controlled by the electromagnetic coil current commutator and input to each superconducting electromagnet. The superconducting electromagnet, which is arranged on the power rotating disc and rotates around the shaft rapidly, is arranged in the vacuum box, input of the liquid nitrogen and the current, and output of the nitrogen are all input and output by the liquid nitrogen and wire inlet and outlet pipe arranged in a middle part of the machine shaft of the power rotating disc. The liquid nitrogen and the current of the superconducting electromagnet arranged in the guide rail are input and output directly from a bottom of the vacuum box. A lower part of the gearbox is fixedly connected with a generator shell, and an upper part of the gearbox is fixedly connected with a bottom plate of the vacuum box. Upper and lower plate surfaces and surrounding sides of the vacuum box are all made of rigid materials, so as to bear an atmospheric pressure. The sealing ring is arranged at a joint of the vacuum box and the machine shaft of the power rotating disc.

In the present invention, the bearing refers to an existing conventional bearing or a magnetic suspension bearing.

In the present invention, under a vacuum working condition, the long rotating crank and the annular slot are arranged around the shaft to form the power rotating disc; the superconducting electromagnet and the superconducting suspension electromagnet which generate the recoil magnetic force are correspondingly arranged in the annular slot and the guide rail, respectively; moreover, the phase change cooling device is adopted to produce and provide the liquid nitrogen, to ensure that the electromagnetic coil is immersed into the liquid nitrogen to realize the circulation of a large-flow current and achieve a theoretical zero resistance, and therefore the huge electromagnetic force is generated. During the rapid advancing of the power rotating disc, the generator is driven by the mechanical kinetic energy formed by the product of the electromagnetic recoil force and the high advancing speed of the power rotating disc, to achieve high-efficiency and large-scale power generation.

### DESCRIPTION OF THE DRAWINGS

The present invention will be described in detail with reference to the attached drawings.

FIG. 1 refers to a schematic structural diagram of a magnetic suspension and electromagnetic force recoil power generation device with a long rotating crank to rapidly rotate around a shaft.

### DETAILED DESCRIPTION OF PREFERRED EMBODIMENTS

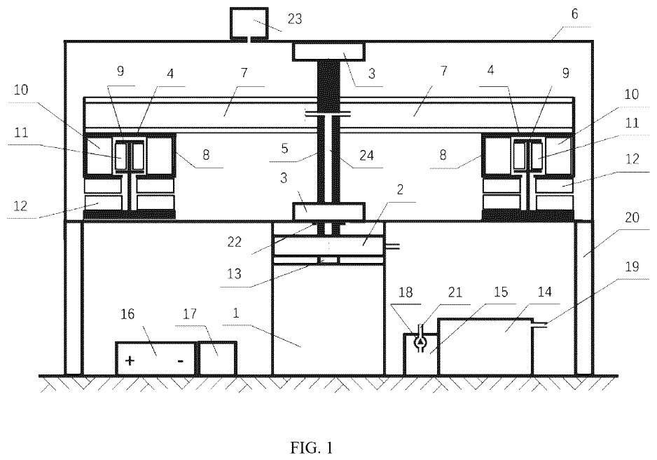

Referring to FIG. 1, the present invention relates to a device for generating electricity by magnetic suspension and electromagnetic force recoil around a shaft with a long rotating handle, which adopts that a power rotating disc is arranged in a vacuum box, and a superconducting electromagnet and a suspended superconducting electromagnet which generate a recoil magnetic force are arranged at an edge of a large-diameter power rotating disc rotating around the shaft rapidly; and make it correspond to the superconducting electromagnet arranged in the guide rail; at the same time, a phase change cooling device is set to provide liquid nitrogen for the superconducting electromagnet efficiently; and the electromagnetic force generated efficiently recoils and pushes the rapid-advancing power rotating disc to drive the generator to generate electricity.

In the present invention, a technological method for a magnetic suspension and electromagnetic force recoil power generation device with a long rotating crank to rapidly rotate around a shaft adopts the long rotating crank to rapidly rotate around the shaft for recoil driven power generation; in a working condition of a vacuum state, a large amount of low-temperature cooling capacity with a temperature lower than −196° C. is provided with high efficiency and low energy consumption by adopting new refrigeration technology and device with an invention name of a phase change cold-refrigerating technological method and a device thereof, so as to ensure that an electromagnetic coil in the power generation device is immersed in liquid nitrogen, so that the electromagnetic coil is in a superconducting state with a zero resistance and circulates a large current; taking a machine shaft of the device as a center, a plurality of long rotating cranks rotating around the shaft rapidly are arranged, an annular slot is arranged below an outer edge of the long rotating crank, and a superconducting electromagnet is fixedly arranged in the annular slot; the long rotating crank, the annular slot and the superconducting electromagnet are combined to form a shaft-rotating power rotating disc; a guide rail is arranged corresponding to a position of the superconducting electromagnet in the power rotating disc at an upper part, a superconducting electromagnet corresponding to the superconducting electromagnet in the annular slot is arranged in the guide rail, and the guide rail is fixedly arranged on a device fixedly connected with the ground in a vacuum state. The superconducting electromagnet at an edge of the power rotating disc rotating around the machine shaft of the device constantly changes a current direction, so that the electromagnet in the guide rail generates an electromagnetic force with the same polarity, thereby forming magnetic suspension to overcome a gravity thereof, and then a recoil thrust of the superconducting electromagnet pushes the generator to generate electricity efficiently. The power rotating disc formed by the long rotating crank and the annular slot and rotating rapidly around the machine shaft is adopted. Due to a large diameter of the power rotating disc, in rapid rotation around the shaft, an advancing linear speed of the superconducting electromagnetic coil arranged in the annular slot at the edge of the power rotating disc is large, and a mechanical kinetic energy formed by a product of a recoil electromagnetic force and an acting distance thereof increases synchronously with the linear speed. Therefore, a physical principle that the acting distance of the force and the generated mechanical kinetic energy increase synchronously with a speed of a vehicle propelled by a recoil thrust is effectively utilized and realized. A magnetic suspension method is adopted to enable the power rotating disc with rapid rotating operation work not produce a mechanical friction with a track. A method for enabling the power rotating disc thereof to rotate rapidly in the vacuum state is adopted, so that an air resistance is not generated during a process of operation work and power generation thereof.

In the present invention, the electromagnetic force in the magnetic suspension and electromagnetic force recoil power generation device with the long rotating crank to rapidly rotate around the shaft refers to that magnetic suspension is realized and an electromagnetic force is generated at a working condition of low-temperature superconductivity; that superconducting magnetic suspension is realized and a superconducting electromagnetic force is generated at a working condition of a normal temperature; further that magnetic suspension is realized and an electromagnetic force is generated at a condition of a normal temperature.

In the present invention, the working condition of the magnetic suspension and electromagnetic force recoil power generation device with the long rotating crank to rapidly rotate around the shaft refers to that the power rotating disc is operated to generate electricity by doing work in the vacuum state, that the power rotating disc is operated to generate the electricity by doing work at a working condition of a normal pressure, further that the power rotating disc is operated to generate the electricity by doing work at a state lower than the normal pressure.

The magnetic suspension and electromagnetic force recoil power generation device with the long rotating crank to rapidly rotate around the shaft as mentioned in the present invention is executed by the technological method.

As shown in FIG. 1, a magnetic suspension and electromagnetic force recoil power generation device with a long rotating crank to rapidly rotate around a shaft includes an electromagnet, and further includes a generator 1, a gearbox 2, a bearing 3, a power rotating disc 4, a machine shaft 5 of the power rotating disc, a vacuum box 6, the long rotating crank 7, an annular slot 8, a guide rail 9, a superconducting electromagnet 10 for generating a recoil magnetic force, a superconducting electromagnet 11 for generating a recoil magnetic force, a superconducting suspension electromagnet 12, a machine shaft 13 of the generator, a phase change cooling device 14, a liquid nitrogen storage tank 15, a storage battery 16, an electromagnetic coil current commutator 17, a working medium pump 18, a nitrogen reflux pipe 19, a vacuum box pillar 20, a nitrogen output pipe 21, a sealing ring 22, a vacuum pump 23, liquid nitrogen, and wire inlet and outlet pipe 24.

In the above-mentioned device, the power rotating disc 4 consists of the machine shaft 5 of the power rotating disc, the long rotating crank 7 and the annular slot 8, wherein a plurality of long rotating cranks 7 are symmetrically arranged, an inner end of the long rotating crank 7 is fixedly connected with the machine shaft 5 of the power rotating disc, and a lower part of an outer end of the long rotating crank is fixedly connected with the annular slot 8; two inner sides of the annular slot 8 are provided with the superconducting electromagnet 10 for generating the recoil magnetic force, so that the recoil magnetic superconducting electromagnet corresponds to the superconducting electromagnet 10 for generating the recoil magnetic force arranged in a vertical direction of the guide rail 9 to generate a recoil electromagnetic force with the same polarity and repulsion; the superconducting suspension electromagnet 12 is arranged at a bottom of the annular slot 8, so that the superconducting suspension electromagnet corresponds to the superconducting suspension electromagnet 12 arranged at a bottom of the guide rail 9 to generates the recoil electromagnetic force with the same polarity and impulsion, which overcomes a gravity on the power rotating disc 4. When the power rotating disc 4 rotates rapidly, a rotating position of the machine shaft 5 of the power rotating disc is fixed by bearings 3 arranged from top to bottom; then a mechanical kinetic energy is transmitted to the gearbox 2, and then the mechanical kinetic energy is transmitted to the machine shaft 13 of the generator after the gearbox 2 changes a speed. Liquid nitrogen produced by the phase change cooling device 14 is first injected into the liquid nitrogen storage tank 15, then pumped into a liquid nitrogen output pipe 21 by the working medium pump 18, and input into the superconducting electromagnets 10, 11 and 12 by a branch pipe respectively, and the nitrogen formed in the superconducting electromagnets 10, 11 and 12 enters the nitrogen reflux pipe 19 through the branch pipe and is input into the phase change cooling device 14; a current in the storage battery 16 is controlled by the electromagnetic coil current commutator 17 and input to the superconducting electromagnets 10, 11 and 12. Input of the liquid nitrogen and the current, and output of the nitrogen of the superconducting electromagnets 10, 11 and 12 arranged on the power rotating disc 4 and rotates around the shaft rapidly, are all input and output by the liquid nitrogen and wire inlet and outlet pipe 24 arranged in a middle part of the machine shaft 5 of the power rotating disc. The liquid nitrogen and the current of the superconducting electromagnets 10, 11 and 12 arranged in the guide rail are input and output directly from the bottom of the vacuum box 6. A lower part of the gearbox 2 is fixedly connected with a generator shell 1, and an upper part of the gearbox is fixedly connected with a bottom plate of the vacuum box 6. Upper and lower plate surfaces and surrounding sides of the vacuum box 6 are all made of rigid materials, so as to bear an atmospheric pressure. A sealing ring 22 is arranged at a joint of the vacuum box 6 and the machine shaft 5 of the power rotating disc.

An operation procedure of the magnetic suspension and electromagnetic force recoil power generation device with the long rotating crank to rapidly rotate around the shaft according to the present invention is as follows:
1. Start the vacuum pump 23 to cleanly extract air in the vacuum box 6.
2. Start the phase change cooling device 14 to efficiently produce liquid nitrogen with a temperature of −196° C. and inject into the liquid nitrogen storage tank 15.
3. Start the working medium pump 18, pump the liquid nitrogen into the liquid nitrogen outlet pipe 21 under pressure, inject into another branch pipe through the liquid nitrogen and wire inlet and outlet pipe 24 in the middle part of the machine shaft 5 of the power rotating disc, and inject the liquid nitrogen into the superconducting electromagnets 10 and 12 to absorb heat and vaporize, then, flow the nitrogen into the nitrogen reflux pipe 19 through the liquid nitrogen and wire inlet and outlet pipe 24 in the middle part of the power rotating disc shaft 5, and finally enter the phase change cooling device 14 for re-liquefaction.
4. Start the working fluid pump 18, pump the liquid nitrogen into the liquid nitrogen output pipe 21 under pressure, and input the liquid nitrogen into another branch pipe through the bottom plate of the vacuum box 6 to inject the liquid nitrogen into the superconducting electromagnets 11 and 12.
5. After cooling the superconducting electromagnets 10, 11 and 12 by the liquid nitrogen, drop the temperature of the electromagnetic coils to −196° C., start the electromagnetic coil current commutator 17, so that the superconducting suspension electromagnets 12 arranged at the bottom of the annular groove 8 and the bottom of the guide rail 9 generate a same repulsive force and generate a suspension magnetic force to suspend the power rotating disc 4 against the gravity.
6. Start the electromagnetic coil current commutator 17, and transmit the current to the superconducting electromagnets 10 and 11 which generate the recoil magnetic force in the annular groove 8 and the guide rail 9 through the middle part of the machine shaft 5 of the power rotating disc and the edge of the vacuum box 6, so as to generate the recoil magnetic force with the same polarity and repulsion and push the power rotating disc 4 to rotate.
7. Under a no-load condition, accelerate a rotating speed of the power rotating disc 4; transmit the mechanical kinetic energy through the gearbox 2 to drive the machine shaft 13 of the generator to run while reaching a set rotating speed.
8. After the generator shaft 13 reaches the set rotating speed, drive the generator 1 to generate electricity with an electric load.

In the present invention, under a vacuum working condition, the long rotating crank and the annular slot are arranged around the shaft to form the power rotating disc; the superconducting electromagnet and the superconducting suspension electromagnet which generate the recoil magnetic force are correspondingly arranged in the annular slot and the guide rail, respectively; moreover, the phase change cooling device is adopted to produce and provide the liquid nitrogen, to ensure that the electromagnetic coil is immersed into the liquid nitrogen to realize the circulation of a large-flow current and achieve a theoretical zero resistance, and therefore the huge electromagnetic force is generated. During the rapid advancing of the power rotating disc, the generator is driven by the mechanical kinetic energy formed by the product of the electromagnetic recoil force and the high advancing speed of the power rotating disc, to achieve high-efficiency and large-scale power generation.

The present invention has a wide range of use, and the application of the present invention in principle, industry and commerce is included in the scope of the claims of the present invention, and any improved technology based on this basis is taken from the claims of the present invention.

We claim:

1. A technological method for a magnetic suspension and electromagnetic force recoil power generation device with a long rotating crank to rapidly rotate around a shaft, adopting the long rotating crank to rapidly rotate around the shaft for recoil driven power generation, wherein a large amount of low-temperature cooling capacity with a temperature lower than −196° C. is provided with high efficiency and low energy consumption by adopting new refrigeration technology and device with an invention name of a phase change cold-refrigerating technological method and a device thereof, so as to ensure that an electromagnetic coil in the power generation device is immersed in liquid nitrogen, so that the electromagnetic coil is in a superconducting state with a theoretical zero resistance, and circulates a large current; by taking a machine shaft of the device as a center, a plurality of long rotating cranks rotating around the shaft rapidly are arranged, an annular slot is arranged below an outer edge of the long rotating crank, and a superconducting electromagnet is fixedly arranged in the annular slot; the long rotating crank, the annular slot and the superconducting electromagnet are combined to form a shaft-rotating power rotating disc; a guide rail is arranged corresponding to a position of the superconducting electromagnet in the power rotating disc at an upper part, a superconducting electromagnet corresponding to the superconducting electromagnet in the annular slot is arranged in the guide rail, and the guide rail is fixedly arranged on a device fixedly connected with ground in a vacuum state; the superconducting electromagnet at an edge of the power rotating disc rotating around the machine shaft of the device constantly changes a current direction, so that the electromagnet in the guide rail generates an electromagnetic force with same polarity and repulsion, thereby forming magnetic suspension to overcome a gravity thereof, and then a recoil thrust of the superconducting electromagnet pushes the generator to generate electricity efficiently; the power rotating disc formed by the long rotating crank and the annular slot and rotating rapidly around the machine shaft is adopted; due to a large diameter of the power rotating disc, in rapid rotation around the shaft, an advancing linear speed of the superconducting electromagnetic coil arranged in the annular slot at the edge of the power rotating disc is large, and a mechanical kinetic energy formed by a product of a recoil electromagnetic force and an acting distance thereof increases synchronously with the linear speed; therefore, a physical principle that the acting distance of the force and the generated mechanical kinetic energy increase synchronously with a speed of a vehicle propelled by a recoil thrust is effectively utilized and realized; a magnetic suspension method is adopted to enable the power rotating disc with rapid rotating operation work not to produce a mechanical friction with a track; and a method for enabling the power rotating disc thereof to rotate rapidly in the vacuum state is adopted, so that an air resistance is not generated during a process of operation work and power generation thereof.

2. The method according to claim 1, wherein the electromagnetic force refers to that magnetic suspension is realized and an electromagnetic force is generated at a working condition of low-temperature superconductivity; that superconducting magnetic suspension is realized and a superconducting electromagnetic force is generated at a working condition of a normal temperature; further that magnetic suspension is realized and an electromagnetic force is generated at a condition of a normal temperature.

3. The method according to claim 1, wherein the working condition refers to that the power rotating disc is operated to generate electricity by doing work in the vacuum state, that the power rotating disc is operated to generate the electricity by doing work at a working condition of a normal pressure, further that the power rotating disc is operated to generate the electricity by doing work at a state lower than the normal pressure.

4. A magnetic suspension and electromagnetic force recoil power generation device with a long rotating crank to rapidly rotate around a shaft, comprising an electromagnet, and further comprising a generator, a gearbox, a bearing, a power rotating disc, a machine shaft of the power rotating disc, a vacuum box, the long rotating crank, an annular slot, a guide rail, a superconducting electromagnet for generating a recoil magnetic force, a superconducting suspension electromagnet, a phase change cooling device, a liquid nitrogen storage tank, a storage battery, an electromagnetic coil current commutator, a working medium pump, a nitrogen reflux pipe, a vacuum box pillar, a sealing ring, a vacuum pump, liquid nitrogen, and a wire inlet and outlet pipe, wherein in the above-mentioned device, the power rotating disc consists of the machine shaft of the power rotating disc, the long rotating crank and the annular slot, a plurality of long rotating cranks are symmetrically arranged, an inner end of the long rotating crank is fixedly connected with the machine shaft of the power rotating disc, and a lower part of an outer end of the long rotating crank is fixedly connected with the annular slot; two inner sides of the annular slot are provided with the superconducting electromagnet for generating a recoil magnetic force, so that the superconducting electromagnet for generating the recoil magnetic force corresponds to the superconducting electromagnet for generating the recoil magnetic force arranged in a vertical direction of the guide rail to generate a recoil electromagnetic force with same polarity and repulsion; the superconducting suspension electromagnet is arranged at a bottom of the annular slot, so that the superconducting suspension electromagnet corresponds to the superconducting suspension electromagnet arranged at a bottom of the guide rail to generate a recoil electromagnetic force with the same polarity and repulsion, which overcomes a gravity on the power rotating disc; when the power rotating disc rotates rapidly, a rotating position of the machine shaft of the power rotating disc is fixed by bearings arranged from top to bottom; then a mechanical kinetic energy is transmitted to the gearbox, and then the mechanical kinetic energy is transmitted to the machine shaft of the generator after the gearbox changes a speed; liquid nitrogen produced by the phase change cooling device is first injected into the liquid nitrogen storage tank, then pumped into a liquid nitrogen output pipe by the working medium pump, and finally injected into the superconducting electromagnet by a branch pipe respectively, and the generated nitrogen enters the nitrogen reflux pipe through the branch pipe and is input into the phase change cooling device; a current in the storage battery is controlled by the electromagnetic coil current commutator and input to each superconducting electromagnet; the superconducting electromagnet, which is arranged on the power rotating disc and rotates around the shaft rapidly, is arranged in the vacuum box, input of the liquid nitrogen and the current, and output of the nitrogen are, are all input and output by the liquid nitrogen and wire inlet and outlet pipe arranged in a middle part of the machine shaft of the power rotating disc; the liquid nitrogen and the current of the superconducting electromagnet arranged in the guide rail are input and output directly from a bottom of the vacuum box; a lower part of the gearbox is fixedly connected with a generator shell, and an upper part of the gearbox is fixedly connected with a bottom plate of the vacuum box; upper and lower plate surfaces and surrounding sides of the vacuum box are all made of rigid materials, so as to bear an atmospheric pressure; and the sealing ring is arranged at a joint of the vacuum box and the machine shaft of the power rotating disc.

5. The device according to claim 4, wherein the bearing is an existing conventional bearing or a magnetic suspension bearing.
